(19) United States
(12) Patent Application Publication
(10) Pub. No.: US 2025/0242433 A1
(43) Pub. Date: Jul. 31, 2025

(54) LASER SCAN HEAD AND PROCESS MONITORING FOR LASER SCAN HEAD

(71) Applicant: nLIGHT, Inc., Camas, WA (US)

(72) Inventors: Giammarco ROSSI, Torino (IT); Andrea BRAGLIA, Torino (IT)

(21) Appl. No.: 19/041,929

(22) Filed: Jan. 30, 2025

Related U.S. Application Data
(60) Provisional application No. 63/627,464, filed on Jan. 31, 2024.

(51) Int. Cl. B23K 26/03; B22F 10/366; B22F 12/41; B23K 26/082; B33Y 30/00; B33Y 50/02

(52) U.S. Cl. CPC B23K 26/032; B22F 10/366; B22F 12/41; B23K 26/082; B33Y 30/00; B33Y 50/02

(57) ABSTRACT

A laser scan head includes a laser to generate a laser beam, one or more optical elements to direct the laser beam to a workpiece, one or more galvo drivers connected to the one or more optical elements to control positions of the one or more optical elements, one or more position detectors associated with the one or more galvo drivers to detect positions of the one or more galvo drivers at predetermined time intervals and generate position signals, at least one photodiode to detect light reflected from the surface of the workpiece at the predetermined time intervals and generate reflected light signals, and at least one controller to receive the position signals and the reflected light signals to associate the position signals with the reflected light signals.

### CROSS-REFERENCE TO RELATED APPLICATION(S)

This United States Non-Provisional Patent Application claims priority to and relies for priority on U.S. Patent Application Ser. No. 63/627,464, filed on Jan. 31, 2024, the entire content of which is incorporated herein by reference.

### FIELD OF THE INVENTION

The present disclosure relates to additive manufacturing, among other manufacturing operations. In particular, the present invention involves an apparatus and method for synchronous process monitoring for a laser scan head that may be used in an additive manufacturing environment.

### BACKGROUND OF THE INVENTION

Laser scan heads have been and continue to be the technology of choice for high performance welding and additive manufacturing, especially powder bed fusion (“PBF”) machines.

Laser scan heads are used to direct laser beams onto a workpiece.

PBF machines direct a laser beam (or multiple laser beams) onto powdered materials, such as powdered metals. After repeated application of the laser beam(s) to the powdered metal, a final, three dimensional product is produced. This is also referred to as three dimensional printing.

While laser scan heads are employed routinely in prior art, laser scan heads are known to present challenges in the current technological environment.

These challenges have been amplified in recent times, because quality assurance for high performance welding and additive manufacturing, especially with respect to powder bed fusion machines, is becoming a highly desirable feature.

It is known that quality assurance may be accomplished by examining the back-reflected light from the weld pool using high speed photodiodes.

The back-reflected light from the weld pool encompasses radiation with a broadband spectrum, containing both laser back-reflection, plasma light (visible and NIR (near infrared)), and thermal radiation (MIR (mid-infrared). This wide range of spectral information is distorted when travelling back from the weld pool to the monitoring photodiode (or photodiodes, if several are used to look at different ranges of the overall spectrum), partly because of the spectral response of the coating of the different optics and partly to the different incident angle on the scan mirrors.

While, for the first distortion (i.e., spectral response of the different optics), compensating measures can be put in place by knowing in advance the fixed optics spectral response, for the second one (i.e., different incident angle on the scan mirrors) an “a priori” correction is not possible as the incident angle on the scan mirrors varies continuously. This fact limits the amount of information that can be extracted and, consequently, limits the effectiveness of the process monitoring.

On top of this, for better data collection and analysis, it may be desirable to correlate the process monitoring data with the position on the working plane.

This is not currently possible, because current power monitoring systems are added to existing scan heads and are not integrated therewith.

These, and other, deficiencies in the prior art call out for one or more solutions.

### SUMMARY OF THE INVENTION

The present invention addresses one or more of the deficiencies in the prior art.

In one embodiment, the present invention provides a laser scan head that includes a laser to generate a laser beam, one or more optical elements to direct the laser beam to a workpiece, one or more galvo drivers connected to the one or more optical elements to control positions of the one or more optical elements, one or more position detectors associated with the one or more galvo drivers to detect positions of the one or more galvo drivers at predetermined time intervals and generate position signals, at least one photodiode to detect light reflected from the surface of the workpiece at the predetermined time intervals and generate reflected light signals, and at least one controller to receive the position signals and the reflected light signals to associate the position signals with the reflected light signals.

It is also contemplated that the at least one controller calculates deviations of the reflected light signals from a predetermined operational sequence.

Still further, for the laser scan head of the present invention, deviations of the reflected light signals from the predetermined operational sequence may be associated with errors.

In one contemplated embodiment, the laser is a fiber laser.

In another contemplated embodiment, the one or more optical elements encompass at least one of mirrors, lenses, collimators, filters, polarizers, and prisms. From these choices, the one or more optical elements may be mirrors.

It is also contemplated that the one or more galvo drivers comprise galvo motors.

In addition, the at least one controller may encompass a first controller to process reflected light from the workpiece and a second controller to process signals to the one or more galvo drivers.

Next, it is contemplated that at least one collimator is disposed between the laser and the one or more optical elements.

Other features and advantages of the present invention will be made apparent from the discussion that follows.

### BRIEF DESCRIPTION OF THE DRAWINGS

The present invention is described in connection with the drawing appended hereto, in which:

FIG. 1 is a graphical illustration of a conventional configuration for an asynchronous operation of a scan head and associated laser;

FIG. 2 is a graphical illustration of a first embodiment of a configuration of a scan head, showing synchronous acquisition of data from the scan head together with asynchronous analysis of the data; and

FIG. 3 is a graphical illustration of a second embodiment of a configuration of a scan head, showing synchronous acquisition of data from the scan head together with synchronous analysis of the data.

### DETAILED DESCRIPTION OF EMBODIMENT(S) OF THE INVENTION

The present invention will now be described in connection with several examples and embodiments. The present invention should not be understood to be limited solely to the examples and embodiments discussed. To the contrary, the discussion of selected examples and embodiments is intended to underscore the breadth and scope of the present invention, without limitation. As should be apparent to those skilled in the art, variations and equivalents of the described examples and embodiments may be employed without departing from the scope of the present invention.

In addition, aspects of the present invention will be discussed in connection with specific materials and/or components. Those materials and/or components are not intended to limit the scope of the present invention. As should be apparent to those skilled in the art, alternative materials and/or components may be employed without departing from the scope of the present invention.

In the illustrations appended hereto, for convenience and brevity, the same reference numbers are used to refer to like features in the various examples and embodiments of the present invention. The use of the same reference numbers for the same or similar structures and features is not intended to convey that each element with the same reference number is identical to all other elements with the same reference number. To the contrary, the elements may vary from one embodiment to another without departing from the scope of the present invention.

Still further, in the discussion that follows, the terms “first,” “second,” “third,” etc., may be used to refer to like elements. These terms are employed to distinguish like elements from similar examples of the same elements. For example, one fastener may be designated as a “first” fastener to differentiate that fastener from another fastener, which may be designated as a “second fastener.” The terms “first,” “second,” “third,” are not intended to convey any particular hierarchy between the elements so designated.

It is noted that the use of “first,” “second,” and “third,” etc., is intended to follow common grammatical convention. As such, while a component may be designated as “first” in one instance, that same component may be referred to as “second, “third,” etc., in a separate instance. The use of “first,” “second,” and “third,” etc., therefore, is not intended to limit the present invention.

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items. The systems, apparatus, and methods described herein should not be construed as limiting in any way. Instead, the present disclosure is directed toward all novel and non-obvious features and aspects of the various disclosed embodiments, alone and in various combinations and sub-combinations with one another. The term “or” refers to “and/or,” not “exclusive or” (unless specifically indicated).

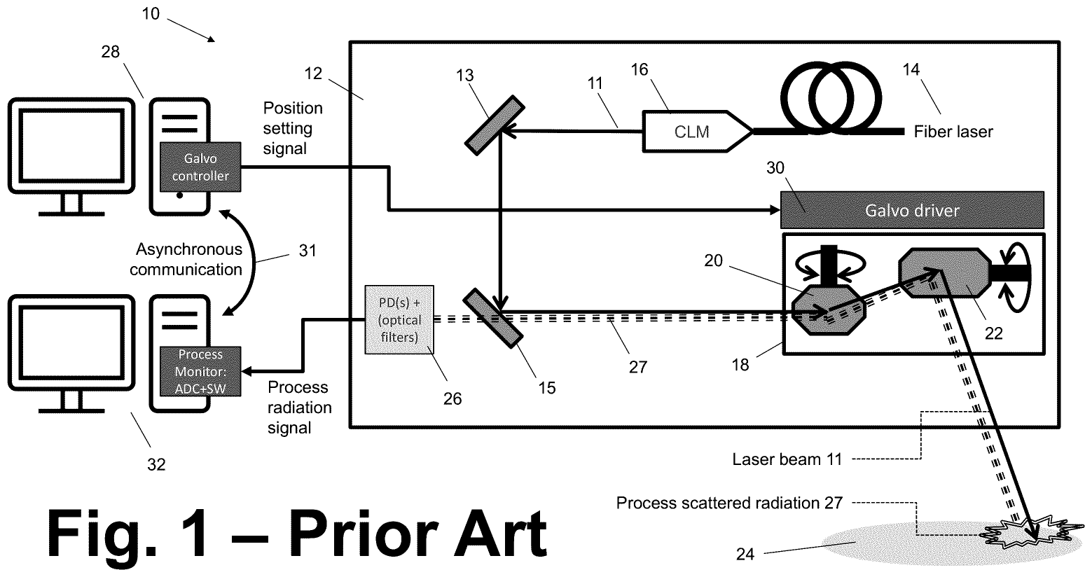

As indicated above, the prior art provides for an apparatus 10 that provides for asynchronous data acquisition about the operation of a scan head 12 and that also provides for asynchronous analysis of the data acquired by the scan head 12. This configuration is illustrated in FIG. 1.

FIG. 1 provides a graphical illustration of one conventional scan head 12 for a laser 14.

As illustrated, the laser 14 generates a laser beam 11 that passes through a collimator 16, where it is directed to the scanner 18. As illustrated, one or more mirrors 13, 15 in the scan head 12 may guide the laser beam 11 from the laser 14 to a scanner 18 within the scan head 12.

As illustrated in FIG. 1, the scanner 18 includes a first scanner mirror 20 and a second scanner mirror 22 that cooperate to direct the laser beam 11 to a workpiece 24.

Reflected light 27, also referred to herein as “process scattered radiation” 27, is reflected from the workpiece 24 and is directed to one or more photodiodes 26.

As also illustrated in FIG. 1, the apparatus 10 includes a first controller 28 that is connected to one or more galvo drivers 30.

“Galvo drivers” 30 are otherwise known as “galvanometer motors” or “galvomotors.” Galvanometer motors are limited-rotation DC motors. Control over the motors is achieved with an internal position detector that enables closed loop servo control of the motor by providing a position signal proportional to the rotation of the motor shaft. The galvo drivers 30 control the positions of the mirrors 20, 22 that focus the laser beam onto the workpiece 24.

The apparatus 10 also includes a second controller 32 that receives signals from the photodiodes 26. The photodiodes 26 detect the reflected light from the workpiece 24.

As noted above, the apparatus 10 operates asynchronously. Specifically, the first controller 28 provides signals to the galvo drivers 30 to control the positions of the mirrors 20, 22 and, thereby, to control the focus point of the laser onto the workpiece 24. Independently from this operation, the photodiodes 26 receive information that is reflected from the workpiece 24 and provide the detected information to the second controller 32. An asynchronous communication link 31 is illustrated in FIG. 1 to illustrate the asynchronous communication between the first controller 28 and the second controller 32.

As should be apparent to those skilled in the art, with this operation, it is possible to detect if there is an error in the manufacture of the workpiece 24 by detecting if there is a deviation (from an expected signal) with respect to the reflected light detected by the photodiodes 26. However, because the operation of the apparatus 10 is asynchronous, it is not feasible to determine what manufacturing error occurred, where on the workpiece 24 the error occurred, or when during the manufacturing process that the error occurred. For the illustrated prior art device, the second controller 32 is able to determine that an error occurred, but any specifics associated with how, when, or where the error occurred cannot be determined.

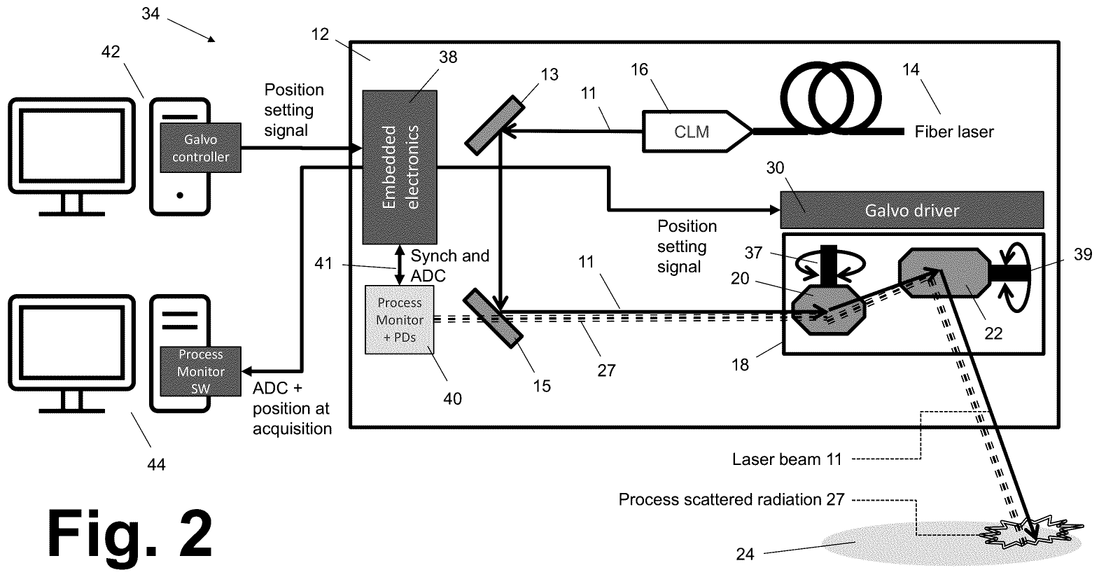

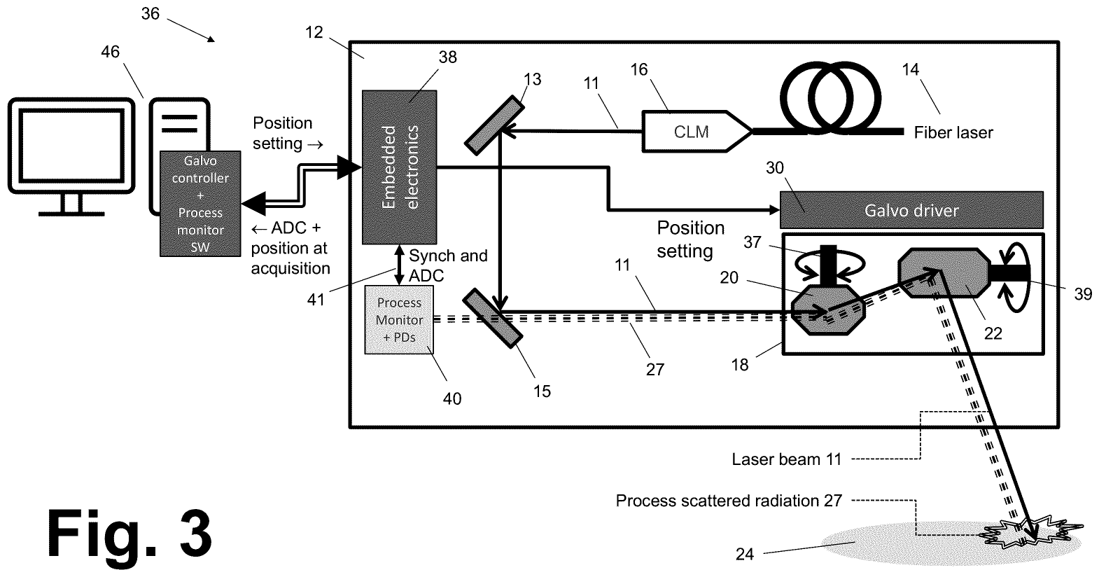

FIGS. 2 and 3 provide two solutions to this problem. The solutions are designated as apparatus 34 in FIG. 2 and apparatus 36 in FIG. 3. The solutions also are designated as laser scan head 34 in FIG. 2 and laser scan head 36 in FIG. 3.

As illustrated in FIGS. 2 and 3, one solution to the prior art problem of asynchronous operation is to incorporate process monitoring circuitry 38 and electronics 40 into the apparatuses 34, 36. Specifically, it is contemplated to incorporate the process monitoring circuitry 38 and electronics 40 within the scan head 12 to synchronize the process monitoring acquisition (e.g., detection of the reflected light 27) with the galvo drive instructions, so that the monitor readings may be associated with each position setting of the scanner mirrors 20, 22.

As illustrated in FIG. 2, the scan head 12 includes a fiber laser 14 and a collimator 16. The fiber laser 14 generates a laser beam 11 that is directed to a workpiece 24 through the collimator 16.

Concerning the embodiments illustrated in FIGS. 2 and 3, while a fiber laser 14 is illustrated, the present invention is not limited solely thereto. Other types of lasers may be employed without departing from the scope of the present invention. Moreover, it is contemplated that the laser 14 generates infrared light that may be used, for example, in welding, brazing, scoring, additive manufacture (e.g., 3D printing), etc. However, the present invention is not limited to any particular wavelength of light for the laser beam 11.

In the embodiment illustrated in FIG. 2, the apparatus 34 includes a first optical element 13 and a second optical element 15. The first and second optical elements 13, 15 are illustrated as mirrors. However, the optical elements 13, 15 may encompass other optical components including, but not limited to, mirrors, lenses, collimators, filters, polarizers, prisms, etc., without departing from the scope of the present invention. In other words, the optical elements 13, 15 are not limited solely to mirrors. Moreover, the optical elements 13, 15 are not limited to singular components. The optical elements 13, 15 may combine two or more optical elements together. For example, the optical element 13 may combine a lens and a mirror.

As shown in FIG. 2, the laser beam 11 is directed to first and second optical elements 20, 22 that are incorporated into a scanner 18. While the optical elements 20, 22 are shown as mirrors, the optical elements 20, 22 may encompass any type of optical element including, but not limited to mirrors, lenses, collimators, filters, polarizers, prisms, etc. As with the optical elements 13, 15, the optical elements 20, 22 are not limited to singular components. The optical elements 20, 22 may combine two or more optical elements together.

In the apparatus 34, the optical elements 20, 22 may be tilted, vibrated, and/or rotated, among other operations known to those skilled in the art, to direct the laser beam 11 to the workpiece 24.

As illustrated, the first and second optical elements are contemplated to encompass mirrors that are connected to one or more galvo drivers 30. The galvo drivers 30 are contemplated to be direct current (“DC”) motors. However, the galvo motors 30 may encompass any other type of motor and/or driver without departing from the scope of the present invention. In the context of the present invention, the galvo drivers 30 are contemplated to tilt, vibrate, and/or rotate the mirrors 20, 22, as required or as desired so that the laser beam 11 is directed to the appropriate locations on the workpiece 24.

Reflected light 27, also referred to as “process scattered radiation” 27 reflects from the workpiece 24 and is directed to a process monitor 40, which may incorporate and/or be connected to one or more photodiodes that detect various aspects of the reflected light 27.

The process monitor is incorporated into the scan head 12, as shown. However, the process monitor 40 need not be incorporated into the scan head 12, as should be apparent to those skilled in the art.

In the illustrated embodiment, the reflected light 27 travels along a reverse path through the scanner 18 to the process monitor 40. It is noted that the travel path of the reflected light 27 is not limited solely to the path illustrated. Instead, the reflected light 27 may travel along any suitable path to the process monitor 40, as should be apparent to those skilled in the art.

To detect the reflected light and generate reflected light signals for operation of the apparatus 34, the process monitor 40 is contemplated to employ one or more photodiodes, as indicated in FIG. 2.

As illustrated in FIG. 2, the scan head 12 is controlled in the context of multiple time frames by the first controller 42. Here, individual time intervals (predetermined time intervals or time frames) may be associated with a specific position target (or specific position targets) for the laser beam 11. As such, each individual time interval is associated with reference points for the positions of the optical elements 20, 22, which direct the laser beam 11 to the workpiece 24. The galvo drivers 30 provide information (e.g., position signals) concerning the positions of the optical elements 20, 22 for each of the predetermined time intervals to the second controller 44 via the embedded electronics 38, as shown. The positions are recorded by the second controller 44. Other information about the galvo drivers 30 also may be provided, such as the motor temperature and any associated alarms.

Position detectors 37, 39 are connected to the optical elements 20, 22 and/or the associated galvo drivers 30 to generate position signals concerning the positions and/or orientations of the optical elements 20, 22.

With continued reference to FIG. 2, it is noted that the first controller 42 provides signals to the galvo drivers 30 to drive the optical elements 20, 22 and, thereby, direct the laser beam 11 onto the workpiece 24 according to a predetermined operational sequence. At the same time, the process monitor 40 receives the reflected light 27 from the workpiece 24 and transmits information concerning the reflected light 27 to the second controller 44, for example. Simultaneously, the positions of motors 30 are recorded and sent to the first controller 42, together with the information about the reflected light 27, so that the exact location of the laser beam 11 on the workpiece 24 may be assessed.

In the embodiment illustrated in FIG. 2, the signals to and from the scan head 12 are synchronously generated by the first controller 42 so that it becomes possible to determine the locations of the optical elements 20, 22 at any point in time.

In this embodiment, the second controller 44 analyzes the signals associated with the reflected light 27 asynchronously. This means that there may be a delay in analyzing the reflected light 27 by the second controller 44. The delay in the analysis performed by the second controller 44 may be very small. Alternatively, the second controller 44 may assess the operation of the apparatus 34 after the operation on the workpiece is complete.

As should be apparent, if the signals associated with the reflected light 27 (also referred to as the “reflected light signals”) that are received by the second controller 44 indicate a deviation from the predetermined operational sequence that is programmed for the manufacturing operation for the workpiece 24, the deviation, or error, may be identified, because that error is identifiable with respect to a specific time interval. The second controller 44 may then be able to adjust the operation of the apparatus 34 to correct the error. Alternatively, the second controller 44 may identify the workpiece 24 as being “defective” and, therefore, slated for recycling, as appropriate.

It is noted that, while the operation of the controller 42 vis-à-vis the second controller 44 may not be synchronous, the two controllers 42, 44 operate such that it is possible to identify where on the workpiece 24 a deviation has occurred from the predetermined operation. Similarly, it is possible to determine when, in the application of the laser beam 11 to the workpiece 24, a deviation has occurred. This is because, for example, the time intervals are associated with operational positions of the optical elements 20, 22.

As indicated above, the process monitor 40 and the embedded electronics 38 cooperate to assist with control of the scanner 18, as indicated by the communication link 41.

Concerning the embedded electronics 38 that assist with operation of the apparatus 34, any suitable electronics may be employed as should be apparent to those skilled in the art.

FIG. 3 illustrated a completely synchronous operation for the apparatus 36.

FIG. 3 shares many of the same components as illustrated in connection with the apparatus 34.

The scanning apparatus 36 includes a fiber laser 14 that cooperates with a collimator 16 to generate a laser beam 11. The laser beam 11 is directed to first and second optical elements 13, 15. From the first and second optical elements 13, 15, the laser beam 11 is directed to a scanner 18.

As before, while the optical elements 13, 15 are illustrated as mirrors, the optical elements 13, 15 may encompass any combination of optical elements including, but not limited to, mirrors, lenses, collimators, filters, prisms, and the like.

The scanner 18 encompasses at least one optical element to direct the laser beam 11 to a workpiece 24. In the embodiment illustrated in FIG. 2, the scanner 18 includes two optical elements 20, 22 that may be controlled to direct the laser beam 11 to specific locations on the workpiece 24. Here, the optical elements 20, 22 are mirrors. However, the optical elements that may be employed include, but are not limited to one or more of mirrors, lenses, collimators, filters, prisms, etc., as discussed hereinabove.

The optical elements 20, 22 are connected to one or more galvo drivers 30 as discussed in connection with FIG. 2. The galvo drivers 30 control the movements and positions of the optical elements 20, 22 to direct the laser beam 11 onto the workpiece 24.

Position detectors 37, 39 are connected to the optical elements 20, 22 and/or the associated galvo drivers 30 to generate position signals concerning the positions and/or orientations of the optical elements 20, 22.

Reflected light 27, also referred to as process scattered radiation 27, is reflected from the workpiece 24. In the embodiment of the scanning apparatus 36, the reflected light 27 travels in the reverse through the optical elements 20, 22 to the process monitor 40. As before, it is contemplated that the process monitor 40 includes and/or is connected to one or more photodiodes to generate reflected light signals that are provided to a main controller 46 via the embedded electronics 38.

In this embodiment, the main controller 46 controls the positions of the mirrors 20, 22 and, in real time, analyzes the reflected light 27 from the workpiece 24. More specifically, the main controller 46 analyzes the reflected light signals provided by the process monitor 40 through the embedded electronic 38, as shown.

As with the apparatus 34, the embedded electronics 38 that assist with operation of the apparatus 36 are contemplated to encompass any suitable electronics as should be apparent to those skilled in the art.

For the apparatus 36, it is possible to detect one or more errors from a predetermined operational sequence in real time. This may permit adjustment of the operation of the apparatus 36 to correct the error in real time. It may also trigger a stop of the apparatus 36 so that a defective workpiece 24 may be discarded to removed for subsequent processing.

The operation of the apparats 36 is contemplated to involve processing of signals from the galvo driver 30 and signals from the process monitor 40, which signals are generated in real time. In one embodiment, the signals from the galvo driver 30 and the signals from the process monitor 40 are generated in association with predetermined time intervals, as discussed in connection with the apparatus 34. As a result, the positions of the optical elements 20, 22 may be correlated with the reflected light signals generated by the process monitor 40. The main controller 46 may then determine if an error has occurred due to a deviation, for example, of the reflected light signals during any one of the predetermined time intervals.

As with the apparatus 34, therefore, the operation of the apparatus 36 permits the identification of when and/or where a deviation from a predetermined operation occurs. As noted, this is possible, at least in part, due to the predetermined time intervals employed.

With respect to the apparatuses 34, 36, it is contemplated that the laser beam that is directed to the workpiece 24 generates the reflected light 27. However, it is also contemplated that a laser 14 with a lower intensity may be employed to scan the workpiece 24 and generate the reflected light 27. In this contemplated embodiment, the low intensity laser beam may be the same laser beam that operates on the workpiece 24. Here, it is understood that the intensity of the laser beam 11 has been lowered by comparison with a laser performing a working operation on the workpiece 24. Separately, the laser 14 may be generated by a completely different laser beam source altogether.

For both of the apparatuses 34, 36, the process monitor 40 and the electronics 38 may be of any type known to those skilled in the art. For example, these elements may incorporate and/or combine one or more field programmable gate arrays (“FPGAs”), digital signal processors (“DSPs”), and the like. Still further, the process monitor 40 and/or the electronics 38 may be processors that execute software (“SW”) for operation of the apparatuses 34, 36.

As noted above, it is contemplated that the process monitor 40 may rely on photodiodes to detect the reflected light from the workpiece 24. The photodiodes that are employed in connection with the process monitor 40 may be of any type known to those skilled in the art. In one contemplated example, the photodiodes may be provided with one or more optical filters so that the photodiodes are adapted to examine specific portions of the electromagnetic spectrum that forms a part of the reflected/process light 27. Other light detection devices also may be employed without departing from the scope of the present invention.

Concerning the operation of the apparatuses 34, 36, the following additional information is provided.

The time frames may be identified with a frame synchronization signal (“frame sync”). As should be apparent to those skilled in the art, one open source system may be the XY2-100 system. Proprietary systems include, for example, serial protocols, such as SL2-100, by Scanlab.

In a possible implementation, the frame sync could be used to trigger the monitoring and acquisition and specifically read values that may then be synchronously associated with the mirror position setting (e.g., the positions of the optical elements 20, 22) and, therefore, to the position of the laser beam 11 on the workpiece 24.

In a specific implementation, a high speed acquisition circuit may be employed to allow capture not of just a single reading, but also of a waveform during an identified time frame. For example, with a frame sync of 100 kHz, i.e. a frame period of 10 μs, a sampling circuit running at 1 MHz could acquire 10 points, one running at 10 MHz, 100 points and so on, with the possibility to apply digital signal processing to those waveforms for better defect identification.

The advantages of this solutions are: (1) calibration of the intensity response as a function of the position(s) of the optical elements 20, 22, i.e., of the back-scattered radiation incident angle. This allows for a more precise evaluation of the radiation intensity and, therefore, more accurate monitoring. This also allows for a correlation between beam position and process emission. As a consequence, it becomes possible to provide: (1) punctual defect identification and also position dependent pass/fail criteria; and/or (2) more accurate data analysis and process optimization.

Without limitation, the present invention is contemplated to be employed in one or more manufacturing environments including, but not limited to, additive manufacturing, laser welding, and laser etching.

In view of the many possible embodiments to which the principles of the disclosed technology may be applied, it should be recognized that the illustrated embodiments are only preferred examples and should not be taken as limiting the scope of the disclosure. We claim as our invention all that comes within the scope and spirit of the appended claims.

1. A laser scan head, comprising:
a laser to generate a laser beam;
one or more optical elements to direct the laser beam to a workpiece;
one or more galvo drivers connected to the one or more optical elements to control positions of the one or more optical elements;
one or more position detectors associated with the one or more galvo drivers to detect positions of the one or more galvo drivers at predetermined time intervals and generate position signals;
at least one photodiode to detect light reflected from the surface of the workpiece at the predetermined time intervals and generate reflected light signals; and
at least one controller to receive the position signals and the reflected light signals to associate the position signals with the reflected light signals.

2. The laser scan head according to claim 1, wherein the at least one controller also calculates deviations of the reflected light signals from a predetermined operational sequence.

3. The laser scan head according to claim 2, wherein deviations of the reflected light signals from the predetermined operational sequence are associated with errors.

4. The laser scan head according to claim 1, wherein the laser is a fiber laser.

5. The laser scan head according to claim 2, wherein the one or more optical elements comprise at least one of mirrors, lenses, collimators, filters, polarizers, and prisms.

6. The laser scan head according to claim 5, wherein the one or more optical elements are mirrors.

7. The laser scan head according to claim 1, wherein the one or more galvo drivers comprise galvo motors.

8. The laser scan head according to claim 1, wherein the at least one controller comprises a first controller to process reflected light from the workpiece and a second controller to process signals to the one or more galvo drivers.

9. The laser scan head according to claim 1, further comprising at least one collimator disposed between the laser and the one or more optical elements.
